(19) United States
(12) Patent Application Publication
(10) Pub. No.: US 2026/0138861 A1
(43) Pub. Date: May 21, 2026

(54) DISPENSING SYSTEM AND METHOD OF USE

(71) Applicant: Guiseppe S. Scionti, Port St. Lucie, FL (US)

(72) Inventors: Guiseppe S. Scionti, Port St. Lucie, FL (US); Jayson Bono, Port St. Lucie, FL (US)

(73) Assignee: Guiseppe S. Scionti, Port St. Lucie, FL (US)

(21) Appl. No.: 19/364,355

(22) Filed: Oct. 21, 2025

Related U.S. Application Data
(63) Continuation-in-part of application No. 18/955,562, filed on Nov. 21, 2024, now Pat. No. 12,448,720.

(51) Int. Cl. B67D 7/02

(52) U.S. Cl. CPC B67D 7/0205; B67D 7/0227

(57) ABSTRACT

A fluid dispensing system may include a body having an interior space, an inlet, and an outlet. The interior space may include a fluid holding area in fluid communication with the inlet and outlet. A plunger is translatable within the interior space between a compressed position and a decompressed position. A biasing member operably couples to the plunger to bias the plunger in a first direction. A trigger operably couples to the plunger. Actuation of the trigger causes the plunger to translate in a second direction, counter to the bias provided by the biasing member. The fluid dispensing system may be used to dispense liquid laundry detergent.

### CROSS-REFERENCE TO RELATED APPLICATIONS

The present application is a continuation-in-part of U.S. patent application Ser. No. 18/955,562, filed Nov. 21, 2024, the contents of which is hereby incorporated herein by reference in its entirety.

### TECHNOLOGY

The present application is directed to fluid dispensing systems. More particularly, the present application is directed to dispensing systems for dispensing measured volumes of laundry detergent.

### SUMMARY

In one aspect, a laundry detergent dispensing system includes a body having an interior space, an inlet, and an outlet. The interior space may include a fluid holding area in fluid communication with the inlet and outlet. A plunger is translatable within the interior space between a compressed position and a decompressed position. A biasing member operably couples to the plunger to bias the plunger in a first direction. A trigger may operably couple to the plunger. Actuation of the trigger may cause the plunger to translate in a second direction, counter to the bias provided by the biasing member.

In one example, the trigger couples to the handle portion at a pivot point fixed relative to the handle portion and includes a first end including a lower portion that extends forward of the handle portion to provide a gap therebetween, wherein the gap increases as the plunger travels toward a decompressed position and decreases as the plunger travels toward a compressed position and a second end that couples to the plunger via a pin received through a slot in the second end. Actuation of the trigger may cause the trigger to pivot on the pivot point to move the lower portion toward the handle portion and decrease the gap therebetween, causing the plunger to translate toward the compressed position to dispense fluid from the outlet. In one configuration, the pivot point is positioned along an upper portion of the handle portion to provide sufficient space for gripping both the handle portion and the trigger during operation. In this or another configuration, the trigger comprises two arms that each pivotably connect to the handle portion wherein each arm couples to the plunger at the second end. In one example, the trigger has a Y-shape with arms that extend along a path having two bends.

In the above or another example, translation of the plunger in the second direction translates the plunger toward the compressed position that at least partially loads the biasing member and translates a face of the plunger relative to the fluid holding region such that an available volume in the fluid holding region is reduced.

In a further example, translation of the plunger in the first direction translates the plunger toward the decompressed position that at least partially unloads the biasing member and translates the face of the plunger relative to the fluid holding region such that an available volume in the fluid holding region is increased.

In any of the above or another example, a travel distance of the face of the plunger within the fluid holding region corresponds to the measured quantity of the fluid dispensed when the trigger is actuated.

In any of the above or another example, the trigger comprises a first end that pivotally couples to a handle portion that extends from the body and a second end that couples to the plunger. The second end includes a slot through which a pin that extends from the plunger is received. Actuation of the trigger may cause the trigger to pivot from the first end while moving the pin to cause the plunger to translate in the second direction as the pin moves through the slot.

In any of the above or another example, the plunger may include a retaining bracket from which the pin extends. The biasing member may couple to the plunger via the retaining bracket.

In any of the above or another example, when liquid detergent is held within the fluid holding region, actuation of the trigger is configured to causes a measured volume of the liquid detergent to be dispensed from the fluid holding region via the outlet. When a fluid reservoir containing the liquid detergent is fluidically coupled to the inlet, subsequent release of the trigger released the bias of the bias member to translate the plunger in the first direction toward a decompressed position that increases an available volume and decreases pressure in the fluid holding region configured to cause the liquid detergent contained within the fluid reservoir to be drawn into the fluid holding region through the inlet.

In a further example, the trigger includes a first end that pivotally couples to the handle portion and a second end that couples to the plunger. The second end includes a slot through which a pin that extends from the plunger is received. Actuation of the trigger causes the trigger to pivot from the first end while moving the pin to cause the plunger to translate in the second direction as the pin moves through the slot.

In any of the above or another example, the biasing member is disposed within the interior space of the body.

In any of the above or another example, the inlet and the outlet each comprise a check valve.

In any of the above or another example, the inlet is positioned to provide a curved or a bended path to the fluid holding region.

In another aspect a method of dispensing laundry detergent includes using a dispensing system comprising a body, a plunger, a biasing member, and a trigger. The body may include an interior space, an inlet, and an outlet, the interior space including a fluid holding area in fluid communication with the inlet and outlet. The plunger may be translatable within the interior space between a compressed position and a decompressed position. The biasing member may operably couple to the plunger to bias the plunger in a first direction. The trigger may operably couple to the plunger. Actuation of the trigger may cause the plunger to translate in a second direction, counter to the bias provided by the biasing member. Using the dispensing system may include actuating the trigger to cause liquid laundry detergent held within the fluid holding region to be dispensed from the outlet, and releasing the trigger to cause liquid laundry detergent to be drawn into the fluid holding region from a fluid reservoir fluidically coupled to the inlet.

In one example, the method includes priming the fluid holding region including repeatedly actuating and releasing the trigger until air within the fluid holding region is expelled and replaced with the liquid laundry detergent from the fluid reservoir.

In the above or another example, actuating the trigger translates the plunger in the second direction corresponding to translation of the plunger toward the compressed position that at least partially loads the biasing member and translates a face of the plunger relative to the fluid holding region such that an available volume in the fluid holding region is reduced.

In a further example, releasing the trigger translates the plunger in the first direction corresponding to translation of the plunger toward the decompressed position that at least partially unloads the biasing member and translates the face of the plunger relative to the fluid holding region such that an available volume in the fluid holding region is increased.

In any of the above or another, the trigger comprises a first end that pivotally couples to the handle portion and a second end that couples to the plunger. The second end may include a slot through which a pin that extends from the plunger is received. Actuating the trigger may cause the trigger to pivot from the first end while moving the pin to cause the plunger to translate in the second direction as the pin moves through the slot.

In any of the above or another example, the plunger comprises a retaining bracket. The biasing member may couple to the plunger via the retaining bracket, and the pin extends from the retaining bracket.

In one example, actuating the trigger causes a measured volume of the liquid detergent to be dispensed from the fluid holding region via the outlet. Releasing the trigger may release the bias of the bias member to translate the plunger in the first direction toward the decompressed position that increases an available volume and decreases pressure in the fluid holding region to cause the liquid detergent contained within the fluid reservoir to be drawn into the fluid holding region through the inlet.

In a further example, the trigger comprises a first end that is pivotally coupled to a handle portion that extends from the body and a second end that couples to the plunger. The second end includes a slot through which a pin that extends from the plunger is received. Actuating the trigger causes the trigger to pivot from the first end while moving the pin to cause the plunger to translate in the second direction as the pin moves through the slot.

In any of the above or another example, the biasing member is disposed within the interior space of the body.

In any of the above or another example, the inlet and the outlet each comprise a check valve.

In any of the above or another example, the inlet is positioned to provide a curved or a bended path to the fluid holding region.

In another aspect, a laundry detergent dispensing system includes a body having an interior space, an inlet, and an outlet. The interior space may include a fluid holding area in fluid communication with the inlet and outlet. A plunger may be translatable within the interior space between a compressed position and a decompressed position. A biasing member may be operably coupled to the plunger to bias the plunger toward the decompressed position. An extension may extend from the plunger that is configured to be manipulated by a user to cause the plunger to translate toward the compressed position. The extension may include a grip configured to be gripped by the user during manipulation of the plunger position.

In one example, the dispensing system includes a tip closure operably coupled to the outlet and configured to selectively block fluid flow from the outlet. In a further example, the tip closure comprises a rotatable member that when rotated opens or closes a fluid path from the outlet.

In an above or another example, one or more measure guides may be positioned along the extension wherein each measure guide represents a measured unit of fluid volume with respect to the interior space. Translation of the plunger as represented by travel of the extension to a measure guide may be utilized to cause a corresponding measured volume of fluid to be dispensed from the outlet.

In any of the above or another example, the body includes a hanger configured to hang the dispensing system when not in use, wherein the hanger includes a structure for coupling to a support structure.

In still another aspect, a dispensing system may include a body defining an interior space, an in-let, and an outlet; a plunger translatable within the interior space; a user-operable mechanism con-figured to cause translation of the plunger to dispense fluid from the outlet, wherein the user-operable mechanism comprises at least one of: (i) a trigger pivotally coupled to the plunger, or (ii) an extension extending from the plunger and configured for manual manipulation.

In yet another aspect, a method of dispensing fluid comprises: providing a dispensing system having a body with an interior space, an inlet, an outlet, a plunger translatable within the interior space, and an extension extending from the plunger; gripping the extension; applying force to the extension to push the plunger toward a compressed position to cause fluid to be dispensed from the outlet; and releasing the extension to allow the plunger to translate toward a decompressed position to cause fluid to be drawn into the interior space through the inlet.

### BRIEF DESCRIPTION OF THE DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 illustrates a dispensing system according to various embodiments described herein;

FIG. 2 illustrates a cross-sectional view of a dispensing system according to various embodiments described herein;

FIG. 3 illustrates a cross-sectional view of a dispensing system according to various embodiments described herein;

FIG. 4 illustrates a dispensing system according to various embodiments described herein;

FIG. 5 illustrates a dispensing system according to various embodiments described herein;

FIGS. 6A & 6B illustrate a dispensing system according to various embodiments described herein, wherein FIG. 6B provides a cross-sectional view of the dispensing system shown in FIG. 6A; and

FIG. 7 illustrates a method of using the dispensing system according to various embodiments described herein.

### DETAILED DESCRIPTION

The present description describes dispensing systems and related methods. In various embodiments, the fluid despising system may be configured with a pump mechanism that is easy to use an operated without an external power source. The dispensing system may be configured to dispenses precise amounts of fluid, minimizing waste. The dispensing system may be provided in various ergonomic designs configured for repeated operation with minimal fatigue to the user. The dispensing system may be beneficially employed to dispense liquid laundry detergents by pulling the detergent from a fluid reservoir such as a commercial laundry detergent bottle.

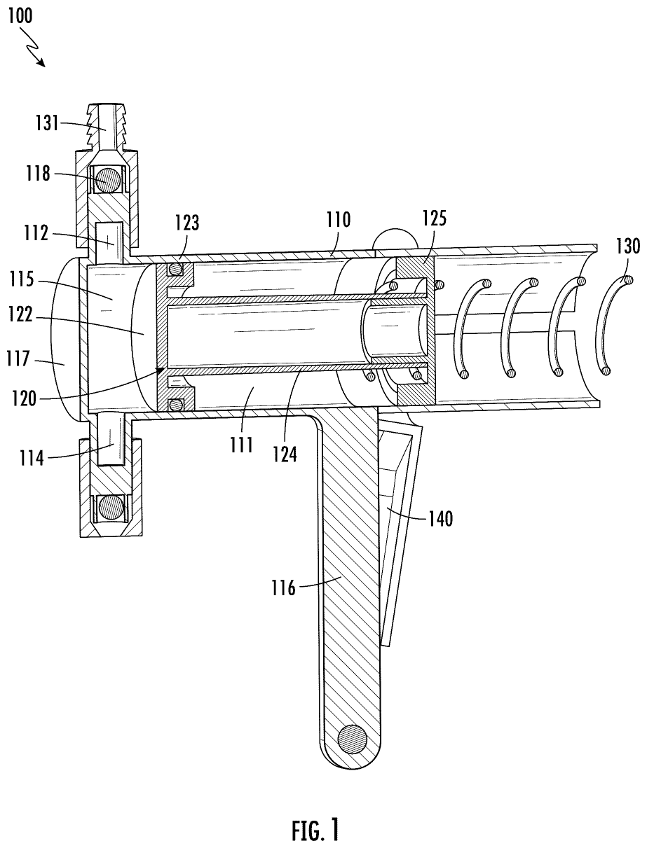

FIGS. 1-6B illustrate a dispensing system 100 according to various embodiments. The dispensing system 100 may include a body 110 having an interior space 111 for holding a fluid, such as a liquid detergent, within a fluid holding region 115. A plunger 120 may be translatable within the interior space 111 of the body 110. The interior space 111 along which the plunger translates may extend along a longitudinal axis. Translation of the plunger 120 may modify a volume, pressure, or both within the fluid holding region 115 to pull fluid into and expel fluid from the fluid holding region 115.

Various embodiments may include one or both of a biasing member 130 or trigger. A biasing member 130 may be provided to bias the plunger 120. A trigger 140 may be operable to cause or enable translation of the plunger 120. In some embodiments, the trigger 140 and biasing member 130 may be operable to translate the plunger 120. For example, the trigger 140 may operate counter to the bias to translate the plunger 120 toward wall 117 and the bias provided by the biasing member 130 may translate the plunger 120 away from wall 117, e.g., when the trigger 140 is released.

The body 110 shown in the illustrated embodiments includes a tubular cylindrical cross-section shape, however, other body shapes. The body 110 may be constructed of suitable material such as plastics, metals, or a combination thereof. In some embodiments, the body 110 may be transparent or semi-transparent, allowing the plunger 120 and the fluid passing through the fluid dispensing system 100 to be visible from the exterior of the fluid dispensing system 100. In an above or another embodiment, the exterior surface of the body 110 may further include measurement indices for visualizing and measuring the amount of fluid dispensed by the dispensing system 100. The body may allow the plunger 120 and the fluid passing through the dispensing system 100 to be visible from the exterior of the dispensing system 100 may extend along a longitudinal axis and define an interior space 111 for retaining fluid.

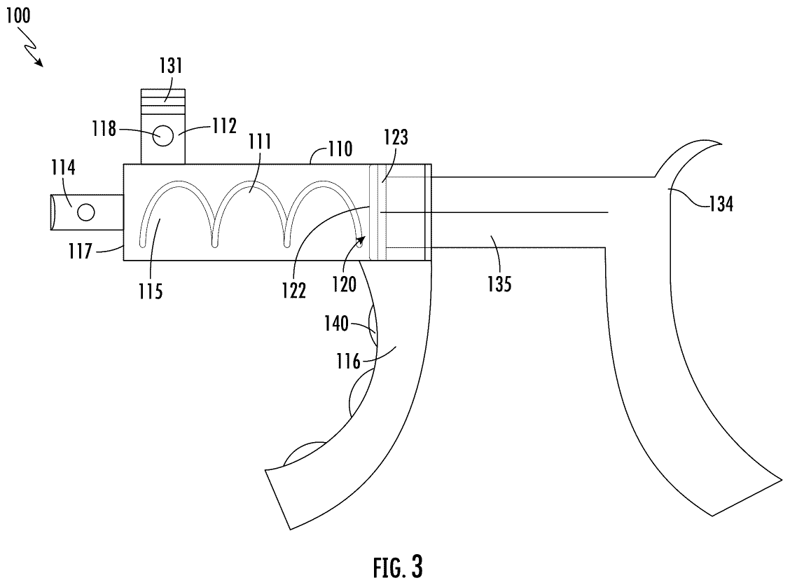

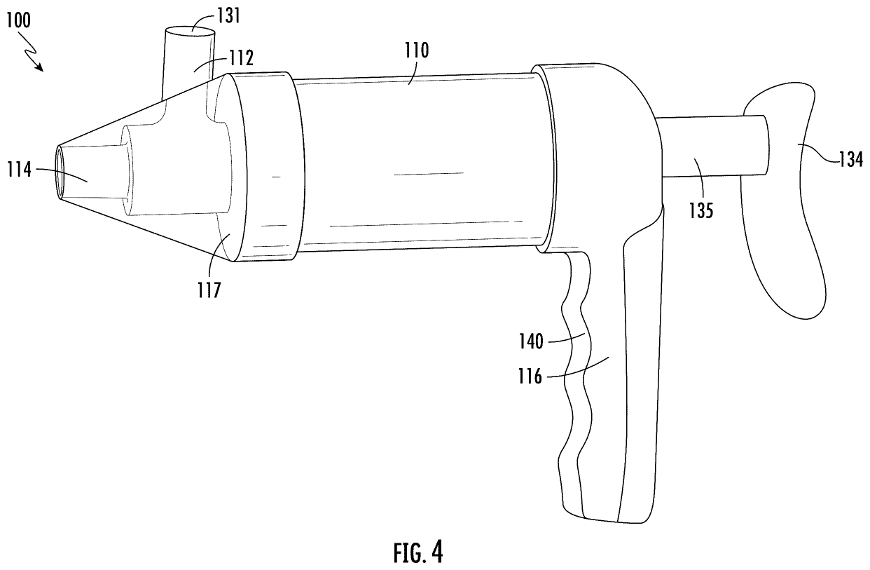

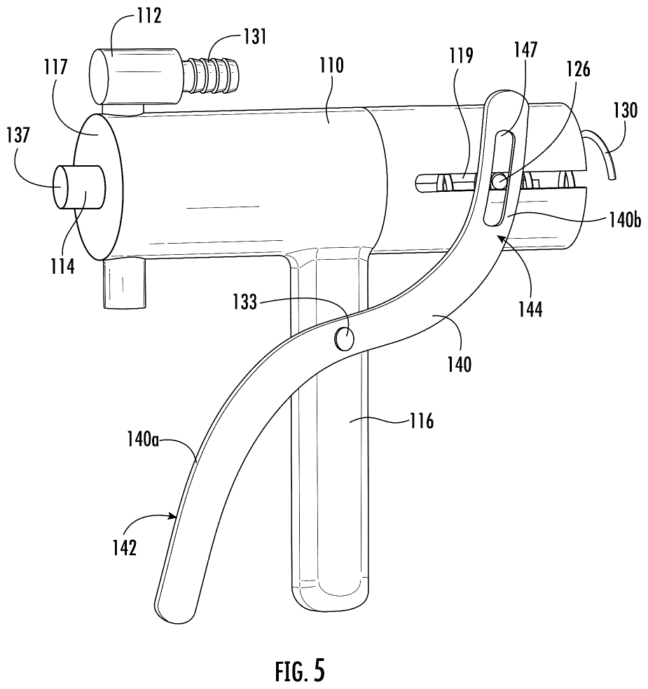

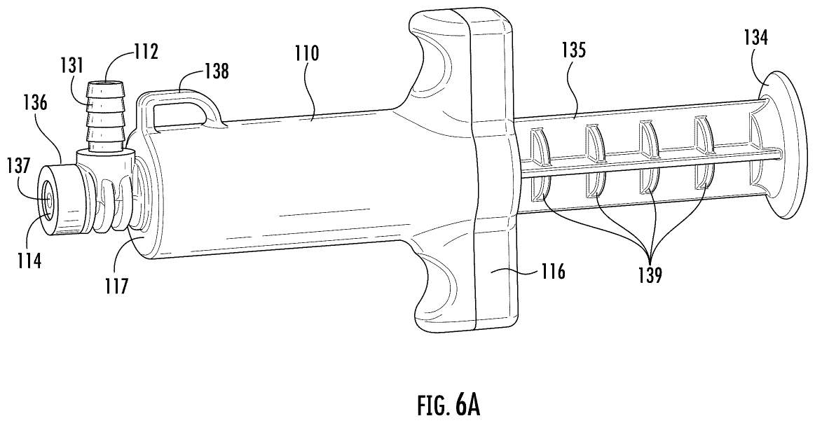

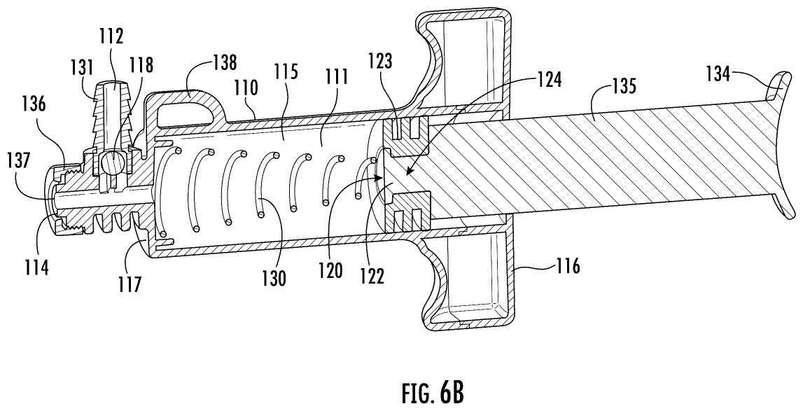

The body 110 may include an inlet 112 and an outlet 114. The inlet 112 and outlet 114 may be in fluid communication with the fluid holding region 115 of the interior space 111. As noted above and described in more detail below, the available volume of the fluid holding region 115 changes with translation of the plunger 120. The inlet 112 and outlet 114 may be in fluid communication with the fluid holding region 115 during respective intake of fluid and dispensing of fluid to communicate fluid therebetween. The inlet 112 and outlet 114 may be disposed on the exterior of the body 110. In the embodiment shown in FIGS. 1 & 2, the inlet 112 and the outlet 114 are generally be disposed opposite one another on the distal end of the body 110. The location of the inlet 112, outlet 114, or both may be modified. The inlet 112, outlet 114, or both may be disposed on an end wall 117 of the body 110 or at other locations along the body 110. For example, in the embodiment shown in FIGS. 3 & 4, the outlet 114 is disposed on end wall 117 of the body 110 and the inlet 112 is disposed on the exterior of the body 110 towards the distal end of the body 110 to the outlet 114. In some embodiments, the inlet 112 and outlet 114 may be integrally formed with the body 110. In other embodiments, the inlet 112 and the outlet 114 may be separably connected to the body 110 by a mating threaded connection. In some embodiments, inlets 112 or outlets 114 may be provided at various orientations with respect to the flow of fluid into or out of the body 110. For example, inlets 112 or outlets 114 may provide a straight path to or from the fluid holding region 115 (e.g., FIGS. 1-3). In one example, inlets 112 or outlets 114 may provide a straight path into a common intake and dispense path (e.g., FIGS. 4, 6A, & 6B), which may also provide a non-straight or path that otherwise includes an angle or turn therealong between the fluid holding region 115 (e.g., inlets 112 illustrated in FIGS. 4, 6A, & 6B). In some embodiments, inlets 112 or outlets 114 may provide non-straight or paths or portions thereof that otherwise include angles or turns between the fluid holding region 115 that do not include a common intake and dispense path. For example, the inlet 112 illustrated in FIG. 5 is orientated at angle to provide a non-straight intake path or an intake path having a turn. The particular inlet 112 shown is positioned at a 90 degree angle. Other embodiments may include inlet 112 or outlet 114 positioned at other angles providing corresponding turns in the path to or from the fluid holding region 115.

In some embodiments, one or both of the inlet 112 or the outlet 114 may include a check valve 118. Various check valve configurations may be used such as duckbill, ball, butterfly, or other suitable valve. In various embodiments, the outlet 114 may include a check valve, such as a duckbill valve, to prevent fluid from being pulled into the fluid holding region 115 through the outlet 114. In some embodiments, the check valve is configured to allow one-way flow from the outlet 114 at a differential pressure between the interior and exterior sides of the outlet 114 corresponding to an elevated interior pressure corresponding to that provided by the biasing member or manual manipulation of a plunger 120 to prevent undesirable fluid flow from the outlet 114. Thus, the outlet 114 may provide a non-drip tip for clean operation. The dispensing system 100 may additionally or alternatively include a tip closure operable to prevent passage of fluid through the outlet 114.

In some configurations, outlets 114 described herein may include tip closures 136 that may be actuated to introduce or otherwise position a physical block to fluid flow from the outlet 114. For example, a tip closure 136 may include a button or rotatable member that when actuated causes movement of a barrier to a fluid path from the outlet 114. Subsequent actuation may be employed to cause removal of the barrier. In one configuration, the barrier is biased to a blocked or unblocked position and actuation of the tip closure 136 is operable to counter or release the bias to transition the barrier between blocked or unblocked positions. As an example, the dispensing system 100 illustrated in FIGS. 6A & 6B includes a tip closure 136. The tip closure 136 is operable to close the outlet 114 to prevent fluid from passing through the outlet 114. The illustrated tip closure 136 comprises a rotatable cap whereby rotation of the cap opens or closes the fluid path from the outlet 114. Thus, unintended dispensing or dripping from the outlet 114 may be prevented via operation of the tip closure 136. The outlet 114 may otherwise include an open path or a check valve design for one-way flow, which may include duckbill valve or other pressure differential check valve design.

In some embodiments, the inlet 112, outlet 114, or both may include a connector for coupling to a hose to thereto. For example, a hose may couple between the inlet and a fluid reservoir, such as a bottle of liquid laundry detergent, and another hose may couple to the outlet at a first end and have a second end positioned with respect to a washing machine to supply the output fluid therein. In the embodiment shown in FIG. 1, the inlet 112 includes a connector 131 for connecting to fluid reservoir containing a fluid detergent via a hose (not shown). The connector 131 comprises a barbed coupling for engaging an inner diameter of the hose via a friction fit. Other connection fittings may be used, e.g., threaded, couplers, compression fittings, or the like.

As introduced above, a plunger 120 may be operable to translate within the interior space 111 of the body 110 to modify the volume and/or pressure of the fluid holding region. The plunger 120 may translate within the interior space 111 in a sealed relationship therewith, e.g., via a gasket 123, and include a face 122 in fluid communication with the fluid holding region 115. For example, the plunger 120 may be translatable between a compressed position wherein movement of the plunger 120 to the compressed position causes fluid in the fluid holding region 115 to be expelled, and a decompressed position wherein movement of the plunger 120 to the decompressed position causes fluid to be pulled into the fluid holding region 115. As explained in more detail below, in some embodiments, the plunger 120 may be translatable to various intermediate compressed or decompressed positions and/or the positions of the plunger 120 may be modified to change the available volume and/or pressure within the fluid holding region 115 between compressed and/or decompressed positions of the plunger 120. The plunger face 122 may be positioned to contact fluid, e.g., liquid detergent, within the fluid holding region 115, however, in other embodiments, the plunger 120 may be operable to modify pressure within the fluid holding region 115 without contacting fluid within the fluid holding region 115.

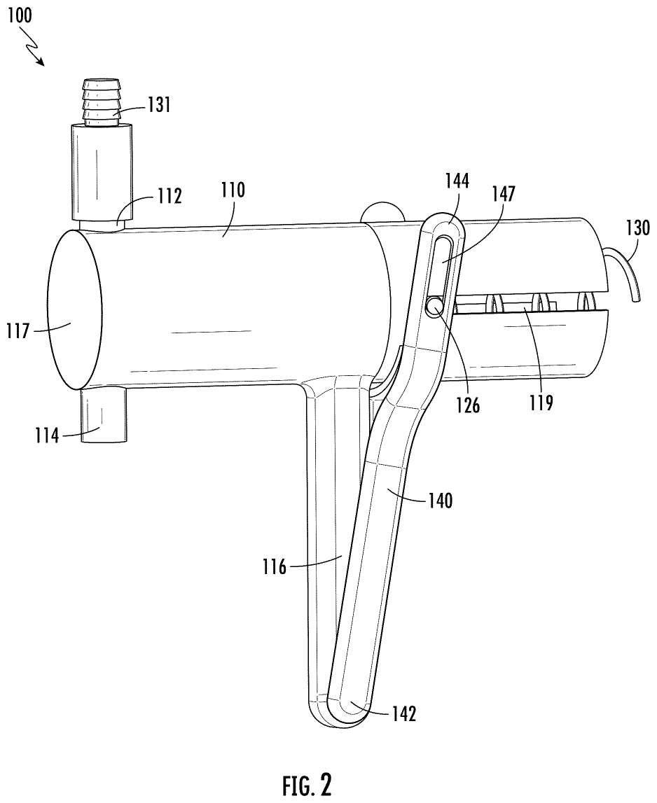

In FIGS. 1, 2, & 4, the plunger 120 is shown in a decompressed position disposed within the interior space 111 of the body 110 and translatable therein. However, in some embodiments, the decompressed position may be operable as a compressed position wherein liquid detergent remains within the fluid holding region 115 after the plunger 120 translates to the compressed position. Thus, the positions of the plunger 120 may be considered relative and with respect to the particular configuration such that translation of the plunger 120 toward a decompressed position may increase volume and/or reduce pressure within the fluid holding region 115 and cause fluid to be pulled into the fluid holding region 115 of the interior space 111 from a fluid reservoir through the inlet 112, and translation of the plunger 120 toward a compressed position may decrease volume and/or increase pressure within the fluid holding region 115 and cause fluid within the fluid holding region to be expelled from fluid holding region 115 through the outlet 114.

The plunger 120 may be operatively coupled to the bias of the biasing member 130 such that the bias translates the plunger 120 toward the compressed position or the decompressed position. The plunger 120 may include a coupling portion 124 for operatively coupling to the bias of the biasing member 130. The coupling may be direct or indirect with respect to the biasing member 130. In the embodiment shown in FIG. 1, the coupling portion 124 connects to the biasing member 130 via a retaining bracket 125 configured to connect to the biasing member 130. In some embodiments, the coupling portion 124, and hence the plunger 120, includes the retaining bracket 125. As described in more detail below, the trigger may operatively couple to the plunger 120 to cause translation of the plunger 120 toward the compressed position or decompressed position. The coupling may be provided at the coupling portion 124.

A proximal portion of the plunger 120 may include the face 122 and gasket 123, which connect to a distal portion of the plunger 120 comprising the coupling portion 124. The proximal and distal portions may be integral or separably connected. The coupling portion 124 may be dimensioned relative to the location of one or more of the bias member 130, handle 116, trigger 140, plunger face 115, or fluid holding region 115 to provide optimal operation. For example, the coupling portion 124 may include an extension that connects the plunger face 115 to the location of the bias, e.g., a retaining bracket 125, biasing member.

As introduced above, a trigger 140 may operatively couple to the plunger 120 wherein operation of the trigger 140 causes or allows the plunger 120 to translate. The trigger 140 may directly or indirectly couple to the plunger 120. The trigger 140 may pivotably or slidably couple to the plunger 120 such that movement, e.g., actuation, of the trigger 140 translates the plunger 120. In some embodiments, the trigger 140 may couple to the plunger 120 via gearing.

In some embodiments, the plunger 120, biasing member 130, and trigger 140 directly or indirectly couple. In FIG. 1, the biasing member 130 engages the plunger 120 at the retaining bracket 125. In FIG. 3, the biasing member 130 is disposed in the interior space 111 of the body 110 between the wall 117 and the plunger face 122. Various biasing members may be employed. In both embodiments, the biasing member 130 comprises a spring. In some embodiments, the biasing member 130 may further include an adjustment element for adjusting the bias of the biasing member 130 as describe further below.

In FIGS. 1 & 2, the trigger 140 operably couples to the handle portion 116, plunger 120 and biasing member 130. The trigger 140 pivotably, slidably, or otherwise couple to the plunger 120, biasing member 130, or both such that operation of the trigger 140 causes translation of the plunger 120. In the illustrated embodiment, the trigger 140 has a first end 142 that is pivotally connected to the handle portion 116 of the body 110 and a second end 144 that is coupled to the plunger 120 via the retaining bracket 125. One or more slots 147 are provided that receive one or more pins 126 that extend from the retaining bracket 125 of the plunger 120. Actuation of the trigger 140 causes the trigger to pivot from the first end 142 to move the pin 126 through a slot 119 in the body 110 toward the handle portion 116. As the pin 126 moves through slot 119, the pin 126 also moves through slot 147 of the trigger 140. The trigger movement causes the plunger 120 to translate within the interior space 111 of the body 110 from a decompressed position to a compressed position (FIG. 1) wherein the fluid volume within the fluid holding region 115 in the interior space 111 is reduced relative to the decompressed position causing fluid to be expelled from the fluid holding region 115. Thus, in the decompressed position the fluid volume within the fluid holding region 115 may retain a greater volume of fluid and in the compressed position less fluid may be retained actuation of the trigger 140 also at least partially loads the biasing member 130. Release of the trigger 140 allows the bias provided by the bias member 130 to translate the plunger 120 to a decompressed position to pull fluid into the fluid holding region 115 via the inlet 112, reloading the fluid holding region 115 with fluid, e.g., liquid detergent. As the plunger 120 is translated to the decompressed position, pin 126 moves through slot 119. Pin 126 also moves through slot 147 to pivot the trigger 140, returning it to its pre-actuated position. Accordingly, release of the trigger 140 may cause translation of the plunger 120 toward a decompressed position that causes fluid to be pulled through the inlet 112 into the increasing available fluid volume of the fluid holding region 115 and actuation of the trigger 140 may drive translation of the plunger 120 toward the compressed position to cause fluid to be expelled from the decreasing volume of the fluid holding region 115 through the outlet 114. In some embodiments, trigger actuation, biasing, and translation of the plunger 120 relationships may be modified. For example, the bias member 130 may be loaded by a lever or knob separate of the trigger 140. In another example, operation of the trigger 140 loads the bias member 130 and a separate trigger or a switch that changes the action of the trigger 140 from a loading operation to a release of bias operation, e.g., via gears, pawls, or both may be employed. In one example, the switch operates such that loading and release of bias are controllable by degree of compression of the trigger 140, e.g., full compression releases bias and partial compression loads bias.

In in FIGS. 3 & 4, the trigger 140 pivotably, slidably, or otherwise couples to the operation of the plunger 120 such that operation of the trigger 140 causes translation of the plunger 120. Actuation of the trigger 140 causes the plunger 120 to translate within the interior space 111 of the body 110 from a decompressed position (FIG. 3) to a compressed position (FIG. 4) wherein the fluid volume within the fluid holding region 115 in the interior space 111 is reduced relative to the decompressed position causing fluid to be expelled from the fluid holding region 115. Thus, in the decompressed position the fluid volume within the fluid holding region 115 may retain a greater volume of fluid and in the compressed position less fluid may be retained. Accordingly, release of the trigger 140 may cause translation of the plunger 120 toward a decompressed position that causes fluid to be pulled through the inlet 112 into the increasing available fluid volume of the fluid holding region 115 and actuation of the trigger 140 may drive translation of the plunger 120 toward the compressed position to cause fluid to be expelled from the decreasing volume of the fluid holding region 115 through the outlet 114. In some embodiments, a biasing member 130 may be disposed within the interior space 111 of the body 110 between the wall 117 and the plunger face 122 or within a sleeve therealong. Actuation of the trigger 140 may also cause a load to be applied to the biasing member 130 when the plunger 120 is in the compressed position. Releasing the trigger 130 may cause the biasing member 130 to release the applied load, causing the plunger 120 to return to the decompressed position. In other embodiments, no biasing member is provided and the movement of the trigger 140 between the decompressed position and the compressed position causing translation of the plunger 120 is manually controlled by the user. For example, the plunger 120 illustrated in FIGS. 3, 4, 6A, & 6B includes an extension 135 that extends reward from the plunger face 122. The extension 135 may be provided to enable manual operation of the plunger 120 by applying force thereto, e.g., pushing and pulling, to translate the plunger 120 between compressed and decompressed positions. The extension 135 may also includes a grip 134 configured to be gripped by a user during manipulation of the plunger 120.

The dispensing system illustrated in FIG. 5 is similar to the dispenser system illustrated in FIGS. 1 & 2 and includes a trigger 140 that is pivotably coupled to the handle 116 at a pivot 133. The illustrated configuration may be used to provide more leverage during dispensing operations. The pivot 133 includes a pivotable connection, such as a pin, that is fixed relative to the handle 116. Depending on the size of the handle 116, the pivot 133 may be provided along an upper portion of the handle 116 or at least along a portion of the handle 116 giving a user sufficient space to grip both the handle 116 and the trigger 140 during operation. The trigger 140 includes a first end 142 including a lower portion 140a that extends forward of the handle 116 providing a gap therebetween that increases as the plunger 120 travels toward the decompressed position and decreases as the plunger 120 travels toward the compressed position. The second end 144 of the trigger 140 couples to the plunger 120 at a coupling, which is illustrated as pin 126. In operation, a user may grip the handle 116 together with the lower portion 140a of the trigger 140 and squeeze to pivot the trigger 140 on pivot 133 and move the lower portion 140a of the trigger 140 toward the handle 116 and decrease the gap therebetween. This relative movement of the trigger 140 and handle 116 on the pivot causes the plunger 120 to travel toward a compressed position for fluid dispensing. Releasing the trigger 140 allows the biasing member 130 to apply a return force to the plunger 120 to drive the same toward a decompressed position and cause fluid intake into the fluid holding region 115. The movement of the plunger 120 causes reward movement of the coupling, pin 126 as shown, through slot 147, moving an upper portion 140b of the trigger 140 rearward and the lower portion 140a of the trigger 140 forward, increasing the gap between the lower portion 140a of the trigger 140 and handle 116 as the trigger 140 pivots on pivot 133. In some embodiments, the trigger 140 may include two pivot connections with the handle 116, one on each lateral side. For example, the trigger 140 may include two arms that each pivotably connect to the handle 116. Each arm may also couple to the plunger at its second end, e.g., to pin 126 within slot 147. First ends 142 of the arms may be connected along the lower portions 140a to assist a user in gripping the trigger 140 and applying even force to the trigger 140. While the trigger 140 is shown as having a Y shape with arms that extend along a path having two bends, some embodiments may include triggers 140 have different shapes.

The dispensing system 100 may be configured to dispense fluid in a measured quantity with each actuation of the trigger 140. The amount of fluid dispensed with each actuation of the trigger 140 may be defined by one or more parameters such as overall dimensions of the body 110 and travel distance of the plunger face 122. The travel distance of the plunger face 122 may be defined as the distance traveled by the plunger face 122 during translation of the plunger 120, e.g., between compressed and decompressed positions.

In some embodiments, the travel distance of the plunger face 122 may be adjustable. For example, the dispensing system 100 may include an adjustable element (not shown) that allows for the amount of fluid dispensed by the dispensing system 100 to be adjusted or changed. The adjustable element may include a knob disposed on the body 110. The knob may engage with the biasing member 130 and the plunger 120 such that rotating the knob clockwise or counter-clockwise adjusts the travel distance of the plunger 120 within the body 110, bias force, e.g., spring tension, or both, in turn changing the amount of fluid dispensed by the dispensing system 100. In some embodiments, the knob may be rotated clockwise or counter-clockwise between a start point and an end point in a continuous manner such that the knob can be rotated to any position between the start point and the end point. Rotating the knob clockwise may increase the travel distance, which in turn increases the amount of fluid dispensed by the dispensing system 100. Rotating the knob counter-clockwise may decrease travel distance, which in turn decrease the amount of fluid dispensed by the dispensing system 100. In another embodiment, the knob may be rotated clockwise or counter-clockwise or a lever or knob may be translated between a number of fixed positions, each position corresponding to a different amount of fluid dispensed by the dispensing system 100.

In an operation of the embodiment of FIGS. 1 & 2, actuation of the trigger 140 may cause the plunger 120 to translate toward a compressed position. As the plunger 120 translates, the biasing member 130 may be loaded to generate potential energy stored in the biasing member 130 in the form of spring tension. As the plunger 120 translates towards the compressed position, pressure within the fluid holding region 115 may also be increased to force fluid within the fluid holding region 115 out through the outlet 114.

When the trigger 140 is released, the potential energy stored in the biasing member 130 may be released, causing the biasing member 130 to retract and, in turn, translate the plunger 120 toward a decompressed position. As the plunger 120 translates towards the decompressed position, pressure within the fluid holding region 115 may be decreased to cause fluid from a fluid reservoir coupled to the inlet 112 to be drawn into the fluid holding region 115 through the inlet 112.

In some embodiments, the dispensing system 100 may need to be primed to dispense the correct amount of fluid. To prime the dispensing system 100, the trigger 140 may be repeatedly squeezed and released until the air within the fluid holding region 115 has been expelled and replaced with fluid, e.g., liquid detergent, from the fluid reservoir.

As introduced above, some embodiments may include manual aspects with respect to manipulating the position of the plunger 120 by directly pushing or pulling the plunger via the extension 135. For example, manual positioning of the plunger 120 via the extension 135 may be used to push, pull, or both push and pull the plunger 120 to dispense fluid, intake fluid, or both. This may be utilized instead of, in addition to, or in conjunction with biasing mechanisms with respect to the position of the plunger 120. With particular reference to FIGS. 6A & 6B, the dispensing system 100 may include an extension 135 configured to be manipulated by the user to cause fluid to be dispensed from the dispensing system. The biasing member 130 biases the plunger 120 toward decompressed positions to cause fluid to be pulled through the inlet 112 into the fluid holding region 115. To dispense fluid from the outlet, the plunger 120 may be pushed toward compressed positions to increase pressure in the fluid holding region to drive fluid from the outlet 114, decreasing available fluid volume in the fluid holding region. For example, a user may manipulate the position of the plunger 120 using the extension 135. As shown, the extension 135 includes a grip 134 configured to be gripped by a user to manipulate the position of the plunger 120. The user may apply force to the grip 134 to push the plunger 120 toward compressed positions and cause fluid to be released from the outlet 114. When the user releases the grip 134, the biasing member 130 applies a return force to the plunger 120 toward decompressed positions. If inlet 112 is in communication with fluid, the fluid may be pulled into the fluid holding region 115 through the inlet 112 as the biasing member 130 causes the plunger 120 to translate toward decompressed positions to refill the fluid holding region 115.

As introduced above, various embodiments of the dispensing system 100 may be configured to dispense measured volumes of fluid measured by various mechanisms such as number or duration of trigger actuations, an adjustable element, or other mechanism to control volume of fluid dispensed, e.g., via control of travel distance of the plunger 120. The embodiment illustrated in FIGS. 6A & 6B, includes one or more measure guides 139 positioned along the extension 135. A measure guide 139 may represent a measured unit of fluid volume with respect to the fluid holding region 115. Thus, translation of the plunger 120, as represented by travel of the extension 135 between positions, may be gaged by the user. As an example, a measure guide 139 may represent a quarter cup of fluid. Pushing the extension 135 to cause the extension 135 to travel from a fully extended position corresponding to a full decompressed position with respect to the plunger 120 to the measure guide 139, e.g., travel of the extension measured from a static or other reference location such as the rear of the body 110, causes a measured volume of a quarter cup of fluid to be dispensed from the outlet 114. In various embodiments, multiple measure guides 139 may be provided for use to measure different fluid volumes. Multiple measure guides 139 may be provided for use to measure fluid volumes via travel between the measure guides 139. The locations of the measure guides 139 may be provided at same or different intervals. In some embodiments, measure guides 139 may be adjustable or otherwise positionable at user defined locations along the extension to provide user defined measured fluid volumes. For example, a measure guide 139 may be provided along a rail and be selectively slidable and lockable in multiple locations along the rail. In another example, the measure guides may be insertable into slots or otherwise lockable into locations along the extension 135.

In various embodiments, measure guides 139 may provide or be selectable to provide a physical stop to the travel of the plunger 120, which may be in one or both directions. For example, a measure guide 139 may includes an extendable structure that a user may selectively extend such that when extended the travel of the plunger 120 toward the compressed position is prevented beyond the measure guide 139.

In various embodiments, the dispensing system 100 may include a hanger 138 for hanging or storing the dispensing system 100 when not in use. An example of which is shown in FIGS. 6A & 6B. The hanger 138 may include a loop, hook, notch, or other structure for looping around, hooking to, latching onto, receiving, or otherwise coupling to another structure to hang or otherwise support the dispensing system 100. As illustrated, the hanger 138 includes a loop structure defining an opening for receiving a support structure, e.g., looping around or hooking to the support structure, to hang the dispensing system 100. While the hanger 138 is illustrated as being positioned along an upper portion of the body 110, hangers 138 may be positioned at other locations along the body 110, handle 116, trigger 140, coupling portion 124, or other location.

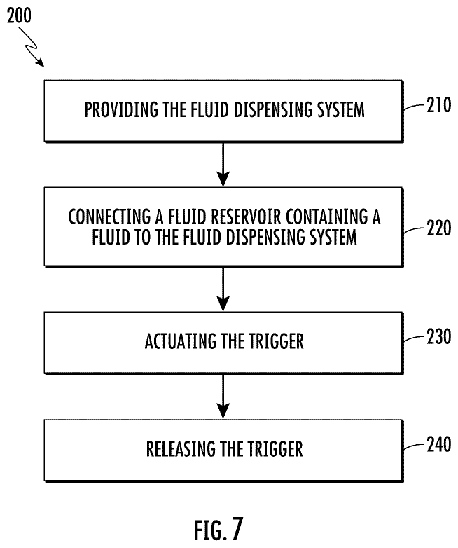

As shown in FIG. 7, a method 200 of using the dispensing system 100 as described above may include the steps of providing the dispensing system 210, connecting a fluid reservoir containing a fluid to the dispensing system 220, actuating the trigger 230, and releasing the trigger 240.

Actuating the trigger 230 may further include translating the plunger to a compressed position and generating spring tension within the biasing member. Actuating the trigger 230 may also cause the fluid within the fluid holding region to be dispensed from the outlet.

Releasing the trigger 240 may further include releasing the spring tension generated within the biasing member and translating the plunger to a decompressed position. Releasing the trigger 240 may also cause the fluid in the fluid reservoir to be drawn into the fluid holding region of the body through the inlet.

In some embodiments, the method 200 may further include the step of priming the fluid holding region. Priming may further include repeatedly actuating and releasing the trigger until air within the fluid holding region is expelled through the outlet and replaced with the fluid from the fluid reservoir.

The dispensing system is generally described herein with respect to dispensing liquid detergent, typically for laundry applications to pull liquid laundry detergent from commercial detergent bottles and dispense the same, but those having skill in the art will appreciate upon reading the present description that the dispensing system and related methods may find applications in dispensing other fluids.

In one embodiment, a dispensing system may include a body, a plunger, and a trigger. The body may define an interior space, an inlet, and outlet, and a handle portion. The plunger may be disposed within the interior space and translatable within the interior space. The biasing member may be disposed within the interior space and engage with a distal portion of the plunger. The trigger may have a first end pivotally connected to the handle portion of the body and a second end pivotally connected the distal portion of the plunger. The body may further include an inlet and an outlet. The inlet and the outlet may be in fluid communication with each other and a fluid holding region within the body. The inlet and the outlet may each comprise a check valve. The inlet may include connector such as a barb for connecting a fluid reservoir. In some embodiments, the distal portion of the plunger may include a set of pins that pivotally connect with the second end of the trigger. In some embodiments, squeezing the trigger may cause the plunger to translate within the interior space of the body from the proximal end of the body to the distal end of the body and create tension within the biasing member. Releasing the trigger may release the tension within the biasing member, causing the plunger to translate within the interior space of the body towards the proximal end of the body. The fluid holding region may be positioned at the proximal end of the body. In some embodiments, squeezing the trigger may also cause a fluid to be dispensed in a measured quantity. Releasing the trigger may cause the fluid to be drawn into the fluid holding region through the inlet. A travel distance of the plunger within the interior space of the body may correspond to the measured quantity of the fluid dispensed when the trigger is squeezed. In some embodiments, the dispensing system may further include an adjustable element for adjusting the amount of fluid dispensed by the dispensing system by adjusting the travel distance of the plunger when the trigger is squeezed. In some embodiments, the fluid holding region may be primed with the fluid by repeatedly squeezing and releasing the trigger drawing the fluid into the fluid holding region through the inlet and expelling air from within the fluid holding region through the outlet.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. For example, any embodiment described herein may include an outlet 114 that includes a check valve. Similarly, any embodiment described herein may be configured with an outlet 114 that does not incorporate a check valve. In some configurations, the embodiments described with respect to FIGS. 1-5 or 7 same be fitted with a tip closure 136, which may be similar to the tip closure 136 described with respect to FIGS. 6A & 6B. The tip closure 136 may be employed with various outlets 114, such as any of those described herein, which may or may not include a check valve configuration. In some configurations, the embodiments described herein may include extensions 135 for manual use, with or without biasing mechanisms. Thus, it is contemplated and understood that this specification supports additional embodiments not expressly set forth in this specification. Such embodiments may be obtained, for example, by combining, modifying, or re-organizing any of the disclosed steps, components, elements, features, aspects, characteristics, limitations, and the like, of the various non-limiting and non-exhaustive embodiments described in this specification.

Various elements described herein have been described as alternatives or alternative combinations, e.g., in a lists of selectable sport challenges, entry fees, financial prizes, sport grounds, etc. It is to be appreciated that embodiments may include one, more, or all of any such elements. Thus, this description includes embodiments of all such elements independently and embodiments including such elements in all combinations.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an application of the described embodiments. Further, the use of a singular noun includes the plural, and the use of a plural noun includes the singular, unless the context of the usage requires otherwise. Additionally, the grammatical conjunctions “and” and “or” are used herein according to accepted usage. By way of example, “x and y” refers to “x” and “y”. On the other hand, “x or y” corresponds to “x and/or y” and refers to “x”, “y”, or both “x” and “y”, whereas “either x or y” refers to exclusivity.

What is claimed is:

1. A laundry detergent dispensing system, the system comprising:
a body having an interior space, an inlet, and an outlet, the interior space including a fluid holding area in fluid communication with the inlet and outlet;
a plunger translatable within the interior space between a compressed position and a decompressed position;
a biasing member operably coupled to the plunger to bias the plunger in a first direction; and
a trigger operably coupled to the plunger, wherein actuation of the trigger causes the plunger to translate in a second direction, counter to the bias provided by the biasing member, wherein the trigger comprises a first end that pivotally couples to a handle portion that extends from the body and a second end that couples to the plunger.

2. The system of claim 1, wherein translation of the plunger in the second direction translates the plunger toward the compressed position that at least partially loads the biasing member and translates a face of the plunger relative to the fluid holding region such that an available volume in the fluid holding region is reduced.

3. The system of claim 2, wherein translation of the plunger in the first direction translates the plunger toward the decompressed position that at least partially unloads the biasing member and translates the face of the plunger relative to the fluid holding region such that an available volume in the fluid holding region is increased.

4. The system of claim 3, wherein a travel distance of the face of the plunger within the fluid holding region corresponds to the measured quantity of the fluid dispensed when the trigger is actuated.

5. The system of claim 1, wherein the second end of the trigger includes a slot through which a pin that extends from the plunger is received, wherein actuation of the trigger causes the trigger to pivot from the first end while moving the pin to cause the plunger to translate in the second direction as the pin moves through the slot.

6. The system of claim 5, wherein the plunger comprises a retaining bracket, wherein the biasing member couples to the plunger via the retaining bracket, and wherein the pin extends from the retaining bracket.

7. The system of claim 1, wherein, when liquid detergent is held within the fluid holding region, actuation of the trigger is configured to cause a measured volume of the liquid detergent to be dispensed from the fluid holding region via the outlet, and wherein, when a fluid reservoir containing the liquid detergent is fluidically coupled to the inlet, subsequent release of the trigger releases the bias of the bias member to translate the plunger in the first direction toward the decompressed position that increases an available volume and decreases pressure in the fluid holding region configured to cause the liquid detergent contained within the fluid reservoir to be drawn into the fluid holding region through the inlet.

8. The system of claim 7, wherein the second end of the trigger includes a slot through which a pin that extends from the plunger is received, wherein actuation of the trigger causes the trigger to pivot from the first end while moving the pin to cause the plunger to translate in the second direction as the pin moves through the slot.

9. The system of claim 1, wherein the first end couples to the handle portion at a pivot point fixed relative to the handle portion and includes a lower portion that extends forward of the handle portion to provide a gap therebetween, wherein the gap increases as the plunger travels toward a decompressed position and decreases as the plunger travels toward a compressed position.

10. The system of claim 9, wherein the second end that couples to the plunger via a pin received through a slot in the second end, and wherein actuation of the trigger causes the trigger to pivot on the pivot point to move the lower portion toward the handle portion and decrease the gap therebetween, causing the plunger to translate toward the compressed position to dispense fluid from the outlet.

11. The system of claim 9, wherein the pivot point is positioned along an upper portion of the handle portion to provide sufficient space for gripping both the handle portion and the trigger during operation.

12. The system of claim 9, wherein the trigger comprises two arms that each pivotably connect to the handle portion wherein each arm couples to the plunger at the second end.

13. The system of claim 12, wherein the trigger has a Y-shape with arms that extend along a path having two bends.

14. The system of claim 1, wherein the biasing member is disposed within the interior space of the body.

15. The system of claim 1, wherein the inlet and the outlet each comprise a check valve.

16. A laundry detergent dispensing system, the system comprising:
a body having an interior space, an inlet, and an outlet, the interior space including a fluid holding area in fluid communication with the inlet and outlet;
a plunger translatable within the interior space between a compressed position and a decompressed position;
a biasing member operably coupled to the plunger to bias the plunger toward the decompressed position;
an extension extending from the plunger and configured to be manipulated by a user to cause the plunger to translate toward the compressed position; and
a grip coupled to the extension and configured to be gripped by the user during manipulation of the plunger position.

17. The dispensing system of claim 16, further comprising a tip closure operably coupled to the outlet and configured to selectively block fluid flow from the outlet.

18. The dispensing system of claim 17, wherein the tip closure comprises a rotatable member that when rotated opens or closes a fluid path from the outlet.

19. The dispensing system of claim 16, further comprising one or more measure guides positioned along the extension, wherein each measure guide represents a measured unit of fluid volume with respect to the interior space and translation of the plunger as represented by travel of the extension to a measure guide causes a corresponding measured volume of fluid to be dispensed from the outlet.

20. The dispensing system of claim 16, wherein the body comprises a hanger configured to hang the dispensing system when not in use, and wherein the hanger includes a structure for coupling to a support structure.
